(19) United States
(12) Patent Application Publication
(10) Pub. No.: US 2015/0042149 A1
(43) Pub. Date: Feb. 12, 2015

(54) VEHICLE WHEEL RIM COVER, VEHICLE WHEEL RIM AND COVER MOUNTING ARRANGEMENT

(71) Applicant: YEN-CHING WANG, KAOHSIUNG CITY 80794 (TW)

(72) Inventor: YEN-CHING WANG, KAOHSIUNG CITY 80794 (TW)

(21) Appl. No.: 13/963,094

(22) Filed: Aug. 9, 2013

(51) Int. Cl. B60B 7/08; B60B 7/14

(52) U.S. Cl. CPC B60B 7/08; B60B 7/14; B60B 2900/113
USPC 301/37.102; 301/37.101

(57) ABSTRACT

A vehicle wheel rim and cover mounting arrangement includes a vehicle wheel rim mounted on equiangularly spaced screw rods of a locating plate at one end of a vehicle wheel axle, a plurality of screw nuts respectively threaded onto the screw rods to lock the vehicle wheel rim to the locating plate, and a vehicle wheel rim cover including a hub, equiangularly spaced mounting through holes accommodating the screw nuts and a locating flange extended from an inner wall thereof around each mounting through hole and having longitudinal crevices and longitudinal flange walls alternatively arranged around the respective mounting through hole and a transverse hook portion located at a distal end of each longitudinal flange wall and forced into engagement with an annular flange of one respective screw nut.

### BACKGROUND OF THE INVENTION

1. Field of the Invention

The present invention relates to vehicle wheel rim cover mounting technology, and more particularly to a vehicle wheel rim and cover mounting arrangement, which facilitates quick installation of the vehicle wheel rim cover without detaching any existing component part or attaching any extra component part, saving the installation labor and cost, and assuring a high level of driving safety.

2. Description of the Prior Art

Referring to FIG. 1, a conventional vehicle wheel rim 10 is shown attached to screw rods 40 of a locating plate 30 at one end of a vehicle wheel axle 20 and locked thereto by nuts 50 that are respectively threaded onto the screw rods 40 after their insertion through respective mounting through holes of the vehicle wheel rim 10.

After fixation of a vehicle wheel rim to a locating plate at one end of a vehicle wheel axle, a cover can be affixed to the outer side of the vehicle wheel rim opposite to the locating plate for visual effects and wheel rim protection.

Further, there are no regulations prohibiting people from installing a vehicle wheel rim cover, however, for safety reasons, it is the basic requirement that the vehicle wheel rim cover cannot fall off the vehicle during movement.

Further, conventional vehicle wheel rim covers commonly have mounting lugs equiangularly arranged around the border area of the inner wall for fastening to respective mounting holes at respective vehicle wheel rims (similar designs are disclosed in Taiwan Patent Numbers M262380, M384777). However, in practice, the mounting holes of vehicle wheel rims from different manufacturers vary in size. After mounting of a vehicle wheel cover at a vehicle wheel rim, the mounting lugs and the respective mounting holes may be not perfectly matched. This matching problem condition cannot be seen from the outer appearance. However, when the vehicle runs over an uneven road surface at a high speed, the vehicle wheel rim cover may be forced to fall off the vehicle wheel rim, affecting traffic safety. Therefore, improvement in this regard is needed.

### SUMMARY OF THE INVENTION

The present invention has been accomplished under the circumstances in view. It is one object of the present invention to provide a vehicle wheel rim cover for fastening to a vehicle wheel rim, which facilitating installation, saving the installation labor and cost, and assuring a high level of driving safety.

To achieve this and other objects of the present invention, a vehicle wheel rim cover of the invention comprises a hub, a plurality of mounting through holes equiangularly spaced around the hub, and a locating flange extended from an inner wall thereof around each mounting through hole. Each locating flange comprises a plurality of longitudinal crevices and longitudinal flange walls alternatively arranged around the respective mounting through hole, and a transverse hook portion located at a distal end of each longitudinal flange wall.

Preferably, the vehicle wheel rim cover further comprises a plurality of radial ribs radially extended from and equiangularly spaced around said hub, and a plurality of openings respectively defined between each two adjacent radial ribs. The mounting through holes are respectively located at the radial ribs.

To achieve this and other objects of the present invention, a vehicle wheel rim and cover mounting arrangement of the invention comprises a vehicle wheel rim mounted on equiangularly spaced screw rods of a locating plate at one end of a vehicle wheel axle, a plurality of screw nuts respectively threaded onto the screw rods to lock the vehicle wheel rim to the locating plate, and a vehicle wheel rim cover attached to the screw nuts and covered on an outer side of the vehicle wheel rim. Further, each screw nut comprises an annular flange extending around the periphery thereof. The vehicle wheel rim cover comprises a hub, a plurality of mounting through holes equiangularly spaced around the hub and adapted for accommodating the screw nuts, and a locating flange extended from an inner wall thereof around each mounting through hole and respectively attached to the screw nuts. Each locating flange comprises a plurality of longitudinal crevices and longitudinal flange walls alternatively arranged around one respective mounting through hole, and a transverse hook portion located at a distal end of each longitudinal flange wall and forced into engagement with the annular flange of one respective screw nut.

Preferably, the vehicle wheel rim cover further comprises a plurality of radial ribs radially extended from and equiangularly spaced around the hub and a plurality of openings respectively defined between each two adjacent radial ribs. Each mounting through hole is located at one respective radial rib.

Preferably, the vehicle wheel rim comprises a plurality of equiangularly spaced openings, and the vehicle wheel rim cover also comprises a plurality of openings respectively defined between each two adjacent radial ribs corresponding to the openings of the vehicle wheel rim.

As stated above, by means of attaching the locating flanges of the vehicle wheel rim cover to the respective screw nuts to force the respective hook portions into engagement with the annular flanges of the respective screw nuts, the vehicle wheel rim cover is firmly secured to the vehicle wheel rim. Thus, the present invention facilitates quick installation of the vehicle wheel rim cover, saving the installation labor and cost, and assuring a high level of driving safety.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is an exploded view of a vehicle wheel rim mounting structure according to the prior art.

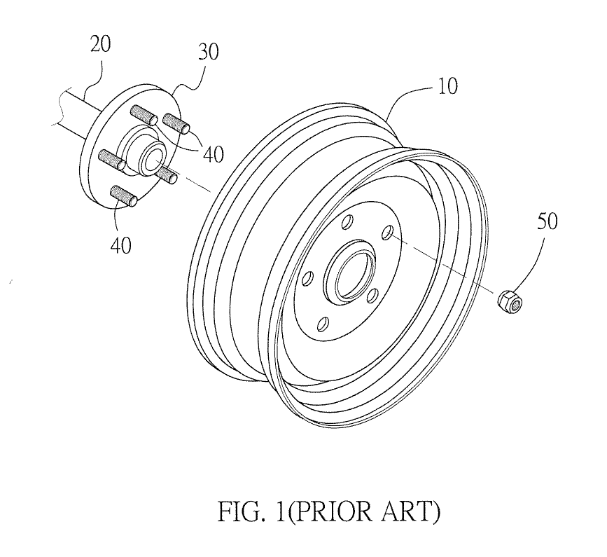

FIG. 2 is an exploded view of a vehicle wheel rim and cover mounting arrangement in accordance with the present invention.

FIG. 3 is an enlarged view of a part of the vehicle wheel rim cover in accordance with the present invention.

FIG. 4 is a main schematic sectional plain view illustrating the mounting operation of the vehicle wheel rim and cover mounting arrangement in accordance with the present invention.

### DETAILED DESCRIPTION OF THE PREFERRED EMBODIMENT

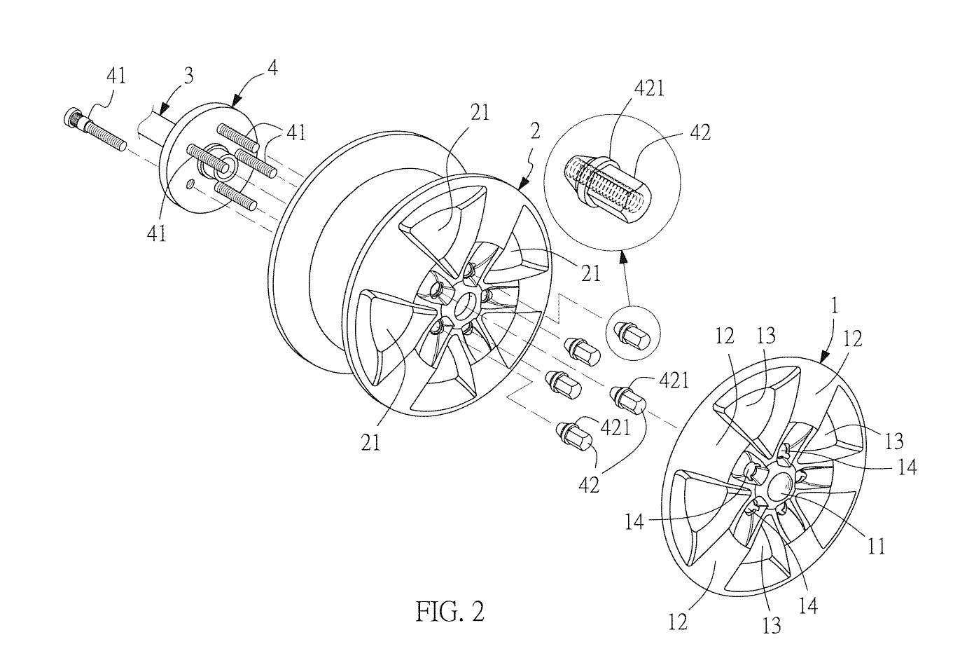

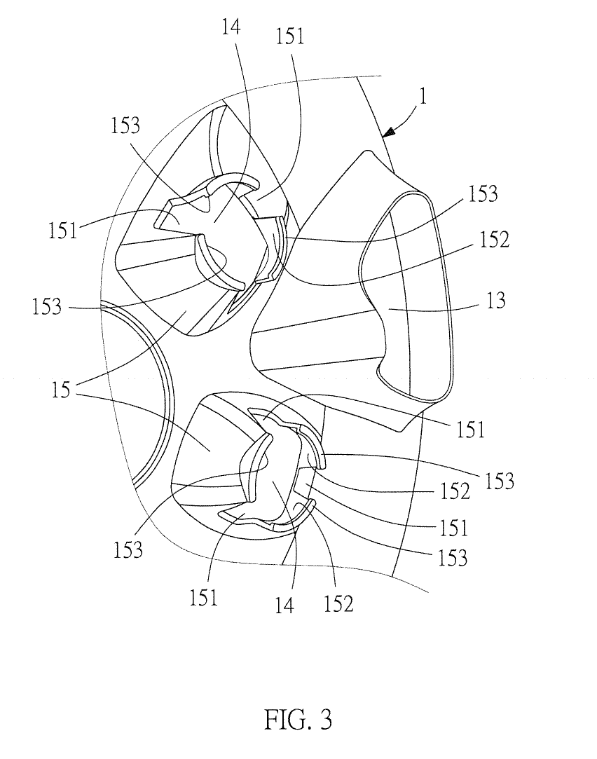

Referring to FIG. 2, a vehicle wheel rim cover 1 in accordance with the present invention is shown for fastening to a rim of a vehicle wheel rim 2. The vehicle wheel rim cover 1 is a plastic product, comprising a hub 11, a plurality of radial ribs 12 each having an inner end thereof perpendicularly connected to the hub 11 and an opposing outer end thereof integrally linked to one another, an opening 13 defined between each two adjacent radial ribs 12, a mounting through hole 14 located at each radial rib 12, and a locating flange 15 extended from an inner wall of each radial rib 12 around the respective mounting through hole 14 (see FIG. 3). Each locating flange 15 defines a plurality of longitudinal crevices 151 and longitudinal flange walls 152 alternatively arranged around the respective mounting through hole 14, and a transverse hook portion 153 located at a distal end of each longitudinal flange wall 152 remote from the respective radial rib 12.

Further, the vehicle wheel rim cover 1 is mounted at an outer side of a vehicle wheel rim 2 (see FIG. 2). The vehicle wheel rim 2 is mounted at an outer side of a locating plate 4 at a vehicle wheel axle 3. The locating plate 4 comprises a plurality of screw rods 41 equiangularly arranged at the outer side thereof. After insertion of the screw rods 41 through (respective mounting through holes of) the vehicle wheel rim 2, a screw nut 42 is threaded onto each screw rod 41 to lock the vehicle wheel rim 2 to the locating plate 4. Further, the mounting through holes 14 of the vehicle wheel rim cover 1 are adapted for accommodating the screw rods 41 and the screw nuts 42. Further, each screw nut 42 has an annular flange 421 extending around the periphery thereof. Further, the vehicle wheel rim 2 comprises a plurality of openings 21 respectively disposed corresponding to the openings 13 of the vehicle wheel rim cover 1.

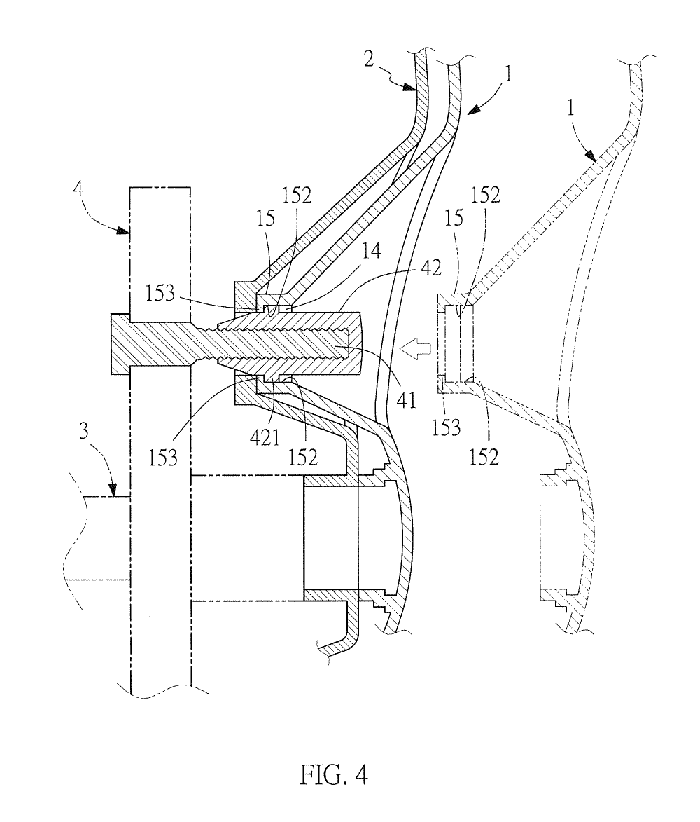

During installation of the vehicle wheel rim cover 1, attach the vehicle wheel rim cover 1 to the vehicle wheel rim 2 to force the respective locating flanges 15 onto the respective screw nuts 42. At this time, the design of the longitudinal crevices 151 of each locating flange 15 enables the longitudinal flange walls 152 to be elastically deformed and the transverse hook portion 153 of each locating flange 15 to be moved over the annular flange 421 of the respective screw nut 42. After the transverse hook portion 153 of each locating flange 15 has been moved over the annular flange 421 of the respective screw nut 42, the longitudinal flange walls 152 are released from the pressure and immediately return to their former shape, forcing the transverse hook portion 153 of the respective locating flange 15 into engagement with the annular flange 421 of the respective screw nut 42 (see FIG. 4). Thus, the vehicle wheel rim cover 1 is firmly secured to the vehicle wheel rim 2 by the screw nuts 42.

As stated above, the vehicle wheel rim cover 1 is locked to the vehicle wheel rim 2 by the screw nuts 42. The screw rods 41 and the screw nuts 42 are the original components designed to lock the vehicle wheel rim 2 to the locating plate 4 at the vehicle wheel axle 3. The mounting of the vehicle wheel rim cover 1 does not need to detach any original component of the vehicle wheel rim 2 and vehicle wheel axle 3 mounting structure or to attach any extra component, facilitating installation, saving the installation labor and cost, and assuring a high level of driving safety.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A vehicle wheel rim cover, comprising a hub, a plurality of mounting through holes equiangularly spaced around said hub, and a locating flange extended from an inner wall thereof around each said mounting through hole, each said locating flange comprising a plurality of longitudinal crevices and longitudinal flange walls alternatively arranged around the respective said mounting through hole and a transverse hook portion located at a distal end of each said longitudinal flange wall.

2. The vehicle wheel rim cover as claimed in claim 1, further comprising a plurality of radial ribs radially extended from and equiangularly spaced around said hub and a plurality of openings respectively defined between each two adjacent said radial ribs, each said radial rib defining one said mounting through hole therein.

3. A vehicle wheel rim and cover mounting arrangement comprising a vehicle wheel rim mounted on equiangularly spaced screw rods of a locating plate at one end of a vehicle wheel axle, a plurality of screw nuts respectively threaded onto said screw rods to lock said vehicle wheel rim to said locating plate, and a vehicle wheel rim cover attached to said screw nuts and covered on an outer side of said vehicle wheel rim, wherein:
each said screw nut comprises an annular flange extending around the periphery thereof;
said vehicle wheel rim cover comprises a hub, a plurality of mounting through holes equiangularly spaced around said hub and adapted for accommodating said screw nuts, and a locating flange extended from an inner wall thereof around each said mounting through hole and respectively attached to said screw nuts, each said locating flange comprising a plurality of longitudinal crevices and longitudinal flange walls alternatively arranged around one respective said mounting through hole and a transverse hook portion located at a distal end of each said longitudinal flange wall and forced into engagement with the annular flange of one respective said screw nut.

4. The vehicle wheel rim and cover mounting arrangement as claimed in claim 3, wherein said vehicle wheel rim cover further comprises a plurality of radial ribs radially extended from and equiangularly spaced around said hub and a plurality of openings respectively defined between each two adjacent said radial ribs, each said radial rib defining one said mounting through hole therein.

5. The vehicle wheel rim and cover mounting arrangement as claimed in claim 4, wherein said vehicle wheel rim comprises a plurality of equiangularly spaced openings; said vehicle wheel rim cover comprises a plurality of openings respectively defined between each two adjacent said radial ribs corresponding to the openings of said vehicle wheel rim.
